(19) United States
(12) Patent Application Publication
(10) Pub. No.: US 2010/0011652 A1
(43) Pub. Date: Jan. 21, 2010

(54) Self-Propelled Cast Fishing System

(76) Inventors: Paul J. von MOHR, Fernandina Beach, FL (US); Dennis WYMAN, Amelia Island, FL (US)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/500,061

(22) Filed: Jul. 9, 2009

Related U.S. Application Data
(60) Provisional application No. 61/134,939, filed on Jul. 15, 2008.

(51) Int. Cl. A01K 91/02

(52) U.S. Cl. 43/19; 43/20

(57) ABSTRACT

The present invention is directed to providing self-propelled casting within a fishing apparatus that is the functional replacement of a conventional rod and reel combination. The system and method of the present invention advantageously include utilization of a self-propelled casting apparatus that employs a compression spring motor to impart a sufficient force on a projectile loaded within a tubular support member, to launch the projectile during a casting cycle. The casting apparatus employs a point-and-release method of safely and accurately casting a bobber or other article of fishing tackle over a specified distance.

### RELATED APPLICATIONS

The present application claims the benefit of U.S. Provisional Application 61/134,939, filed Jul. 15, 2008, the entire specification of which is incorporated herein by reference.

### FIELD

The present invention relates in general to methods and devices utilized for fishing, and in particular to an improved apparatus and method for projecting or casting a lure, bait, sinker, or other article of fishing tackle or projectile from a user-handled fishing device and a comprehensive and integrated fishing system and method for use with the same.

### BACKGROUND

Fishing is a popular sport and continues to grow in popularity as a sport and recreational activity. Different fishing styles and conditions require differing fishing equipment including different types of rods, reels, line, bait, lures, floats, sinkers, etc.

One of the most fundamental of all fishing techniques is that of “casting” a fastened bait or lure article into a desired location on the water. A person handling a rod-and-reel combination casts a bait using a rotational motion of the rod. In this manner, the rod is utilized to “throw” the bait in much the same way as an arm throws a ball or a stone. The rod starts in a tilted back position opposite the intended cast direction while the bait is typically pulled up and held near the rod tip. When the cast is started, the fishing line must be manually or mechanically “locked” to the rod and reel so that the bait will, upon release, properly follow the direction of the rod tip. As the rod is rotated forward, the relatively high velocity at the tip of the rod imparts a corresponding velocity on the bait which then travels in a direction and to a distance as determined by the force and direction applied in the rotation. Casting, along with other manual fishing techniques, often poses considerable challenges for younger, novice, or handicapped anglers.

A longtime favorite fishing setup that is particularly well-suited for younger or inexperienced anglers includes a so-called closed-face spincast reel together with a suitable rod. Spincast reels are well known to fishermen and are widely produced and readily available in most retail stores that carry fishing equipment and gear. By design, spincast reels provide for relatively simple fine spooling and handling features, making them a popular choice for younger or less experienced anglers. Although spincast reels address many of the problems associated with line handling, the ability to accurately and safely cast fishing tackle having exposed hooks remains a barrier for many would-be anglers. The technique required for casting also poses substantial difficulties often to the extent that the individual simply cannot cast effectively and must rely on an experienced angler to perform the casting portion of the fishing experience.

Another problem occurs when fishing in close proximity to other people or near a structure that limits the possible range of motion during casting. Such situations may frequently arise, for example, on crowded boats, piers, and banks in which swinging fishing tackle having exposed hooks poses a significant hazard to oneself and/or nearby persons. In these situations, the ability to deliver a bait or lure to a desired location on the water is substantially limited by the mechanics of conventional manual casting techniques which require the angler to swing, sway, roll, flip, or otherwise move the end of the fishing rod or pole to effectuate a directed launching of the lure or bait.

It can therefore be appreciated that a need exists for an improved device and method for addressing the foregoing problems associated with casting fishing tackle easily, safely, and accurately. The self-propelled cast fishing system addresses such a need.

### SUMMARY

In one aspect, the present application is directed to a self-propelled cast fishing system. The fishing system includes a launch mechanism which includes a tubular support member with a bore, a first end and a second end, a compression spring fixedly positioned at the first end of the tubular support member, a retaining mechanism for retaining the compression spring in a compressed position, and a release mechanism for releasing the compression spring to an extended position. The system further includes a safety interlock mechanism which prevents activation of the release mechanism when in a rest state and allows activation of the release mechanism when in an activated state. Further components of the fishing system include a reel, an article of fishing tackle which can be positioned within the bore of the tubular support member such that activation of the release mechanism acts to propel the article of fishing tackle from the second end of the tubular support member, and fishing line with a first end and a second end, the first end fixed to the reel and the second end fixed to the article of fishing tackle.

It is to be understood that other aspects of the present self-propelled cast fishing system will become readily apparent to those skilled in the art from the following detailed description, wherein various embodiments are shown and described by way of illustration. As will be realized, the self-propelled cast fishing system is capable of other and different embodiments and its several details are capable of modification in various other respects, all without departing from the spirit and scope of self-propelled cast fishing system described. Accordingly the drawings and detailed description are to be regarded as illustrative in nature and not as restrictive.

### BRIEF DESCRIPTION OF THE DRAWINGS

Referring to the drawings wherein like reference numerals indicate similar parts throughout the several views, several aspects of the applicant's self-propelled cast fishing system are illustrated by way of example, and not by way of limitation, in detail, wherein:

FIG. 1A is a perspective front view of one embodiment of the applicants' self-propelled cast fishing system;

FIG. 1B is a partial perspective front view of the embodiment shown in FIG. 1A with the flex tip assembly extended;

FIG. 2 is a perspective front view of the embodiment shown in FIG. 1A, with cover panels removed to show internal components;

FIG. 3 is a perspective front view of the embodiment shown in FIG. 1A, showing additional internal components;

FIG. 4 is a perspective front view of the embodiment shown in FIG. 1A, showing further internal components;

FIG. 5 is an exploded view of the launch mechanism, the flex tip assembly and the article of fishing tackle of the embodiment shown in FIG. 1A;

FIG. 6 is an exploded view of the flex tip assembly of the embodiment shown in FIG. 1A;

FIG. 7A is an exploded view of the safety interlock mechanism portion of the embodiment shown in FIG. 1A;

FIG. 7B is a perspective top view of a portion of the safety interlock mechanism portion of the embodiment shown in FIG. 1A;

FIG. 8A is a rear end plan view of the embodiment shown in FIG. 1A, with the safety interlock knob in the position allowing depression of the knob;

FIG. 8B is a rear end plan view of the embodiment shown in FIG. 1A, with the safety interlock knob in a position preventing depression of the knob;

FIG. 9 is a side perspective view of the reel assembly portion of the embodiment shown in FIG. 1A;

FIG. 10 is a front perspective view of the line release mechanism of the reel assembly portion of the embodiment shown in FIG. 1A;

FIG. 11A is a partial side perspective view of the line release mechanism of the reel assembly portion of the embodiment shown in FIG. 1A, with the catch pin extended;

FIG. 11B is a partial side perspective view of the line release mechanism of the reel assembly portion of the embodiment shown in FIG. 1A, with the catch pin retracted;

FIG. 12A is a front perspective view of the article of fishing tackle portion of the embodiment shown in FIG. 1A, shown in the closed position; and

FIG. 12B is a front perspective view of the article of fishing tackle portion of the embodiment shown in FIG. 1A, shown in the open position.

### DETAILED DESCRIPTION

The present self-propelled cast fishing system is described in at least one embodiment in the following description with reference to the figures. It will be appreciated by those skilled in the art that variations may be accomplished in view of these teachings without deviating from the spirit or scope of the present invention.

The present self-propelled cast fishing system is generally directed to an improved fishing apparatus, system and method that overcome problems relating to safety, accuracy and difficulty encountered when using conventional hand-held cast fishing devices to cast a fastened article of fishing tackle which may be a lure or bait or any other article or body or projectile that is attached to a fishing line and included among the material cast from the apparatus. In addition to addressing the issues facing novice or handicapped anglers, the present self-propelled cast fishing system employs a point-and-release casting method that eliminates problems encountered with swing or arc casting, enabling anglers to easily and safely cast in crowded spaces or limited-space environments such as when casting from under overhead manmade or natural obstructions such as power lines or tree branches. Furthermore, the present self-propelled cast fishing system is compact and easily portable and does not require any other protective casing for transport or storage. To this end, and as further depicted and explained with reference to the figures, the present self-propelled cast fishing system includes a self-propelled casting apparatus that advantageously employs a compression spring to provide a motive force to the article of fishing tackle. The present self-propelled cast fishing system further encompasses a protective bobber advantageously utilized in combination with a tubular casting apparatus to improve casting and tackle handling safety.

The various features and components of the self-propelled cast fishing system are now described with reference to the Figures.

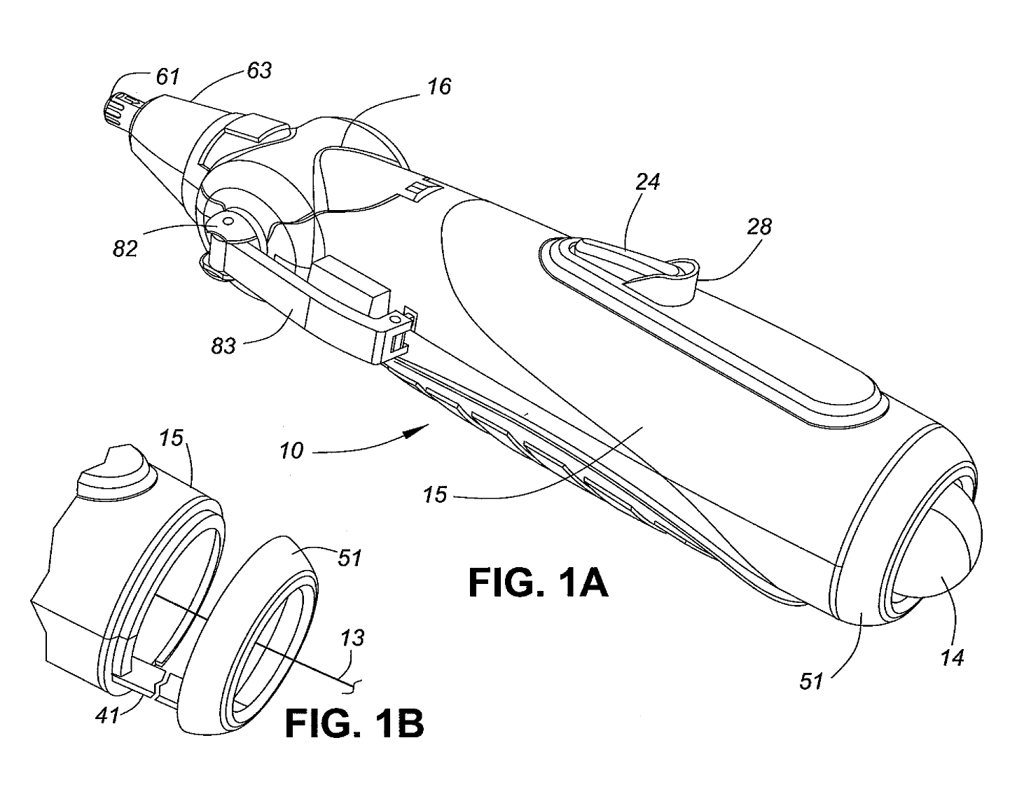

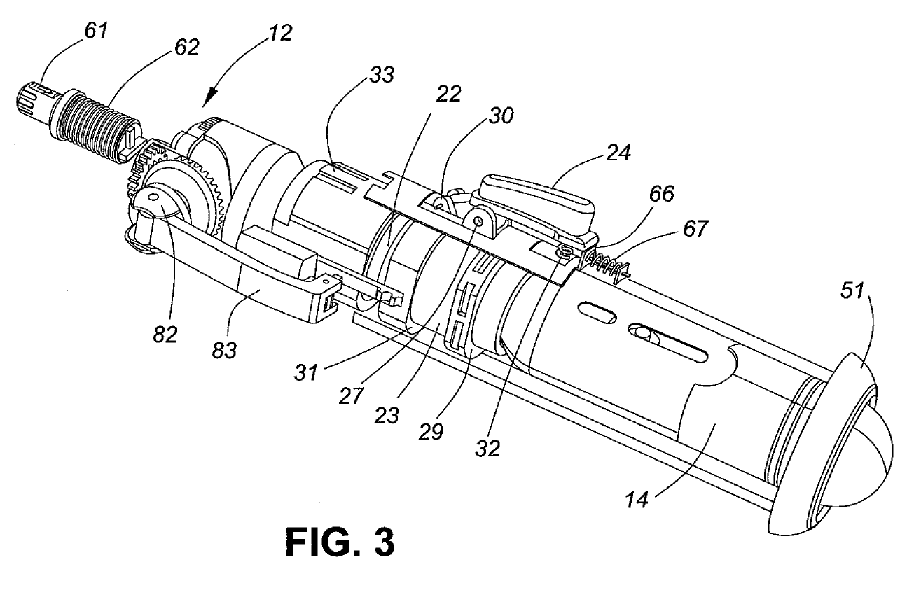

Referring to FIGS. 1A, 2 to 4 and 9, in at least one embodiment, the self-propelled cast fishing system 10 comprises a launch mechanism 11, a reel 12 including fishing line 13, and an article of fishing tackle 14 attached to fishing line 13. The launch mechanism 11 and reel 12 are enclosed in external covers 15 and reel cover 16, which are designed to cover and shield the internal working components from contact with the user, as well as to provide external styling that appeals to the eye and to provide ergonomic hand grips for the operator. The covers further serve to protect the line 13 and reel 12 from getting tangled or damaged during storage and transport, eliminating the need to provide a separate storage container. In addition, in at least one embodiment, reel 12 is a self-contained unit which is not permanently attached to self-propelled cast fishing system 10, and reel cover 16 is readily opened to allow an operator to easily remove the reel 12 for maintenance or service, such as repairing broken fishing line.

### Launch Mechanism

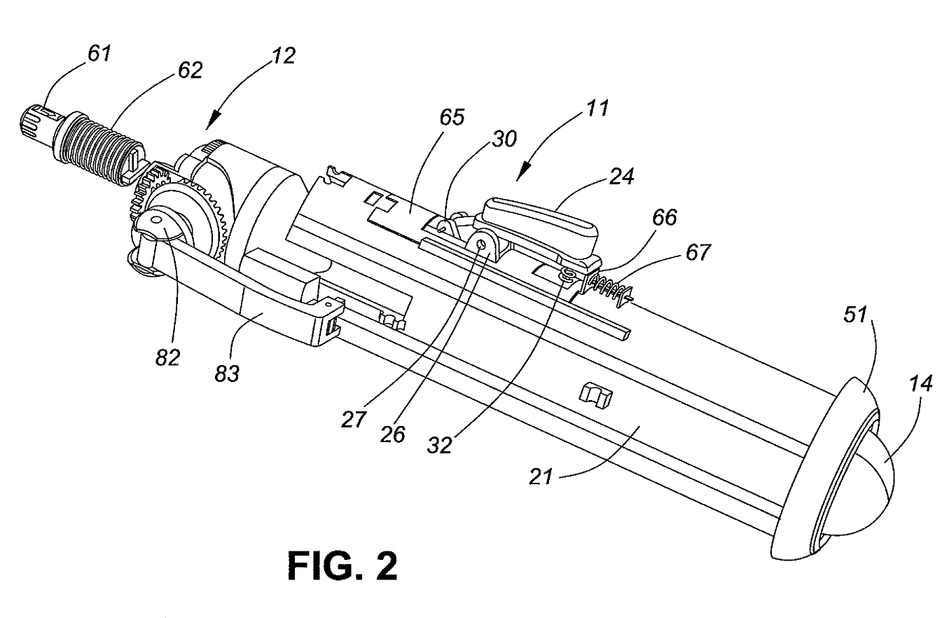

As shown in FIGS. 2 to 5, in at least one embodiment, the launch mechanism 11 includes a tubular support member 21, a compression spring 22, a launch shuttle 23, and a launch trigger 24.

The tubular support member 21 is a hollow tube with an internal stop at the front end comprised of a stop shoulder 25 which prevents the shuttle 23 from being propelled out the end of the tubular support member 21 along with the fishing tackle 14. Tubular support member 21 also includes external molded features 26 that locate the launch trigger 24, allowing it to pivot about pivot pin 27. Tubular support member 21 is conveniently made of molded plastic, but can be made of any suitable material known in the art.

The launch shuttle 23 is a tubular slider device that glides inside the bore of tubular support member 21, making contact with the compression spring 22 at one end, and the article of fishing tackle 14 at the other end. The launch shuttle 23 has a mating stop face 29 that contacts the above mentioned stop shoulder 25 on the inside of the tubular support member 21. The launch shuttle 23 also engages the pawl 30 of the launch trigger 24 at mating stop face 31, to hold the compression spring 22 in the “armed” state until the operator chooses to discharge the article of fishing tackle 14.

The compression spring 22 provides the launch force to propel the article of fishing tackle 14. In its “home” or expanded position, it will bias mating stop face 29 of the launch shuttle 23 against the stop shoulder 25. In the “armed” or compressed position, it will bias mating stop face 31 of the launch shuttle 23 against the launch trigger pawl 30.

The launch trigger 24 is a pivoting lever which has a pawl 30 at one end that engages mating stop face 31 of the launch shuttle 23. A small bias spring 32 keeps the pawl 30 engaged until the operator depresses the trigger 24. As described in detail below, the launch trigger 24 engages safety interlock mechanism 60 so as to prevent actuation until the operator depresses and holds the safety interlock knob 61. Bump guard 28, located on external cover 15 (FIG. 1A), also acts to prevent accidental actuation of launch trigger 24.

The end cap 33 is a fixed part of the launch mechanism 11 and acts to cap off the tubular support member 21 after the above mentioned components are assembled and to restrain the spring force of compression spring 22. End cap 33 is conveniently snap fit and glued to the tubular support member 21, but may also be attached with screws or in any other similar manner known in the art.

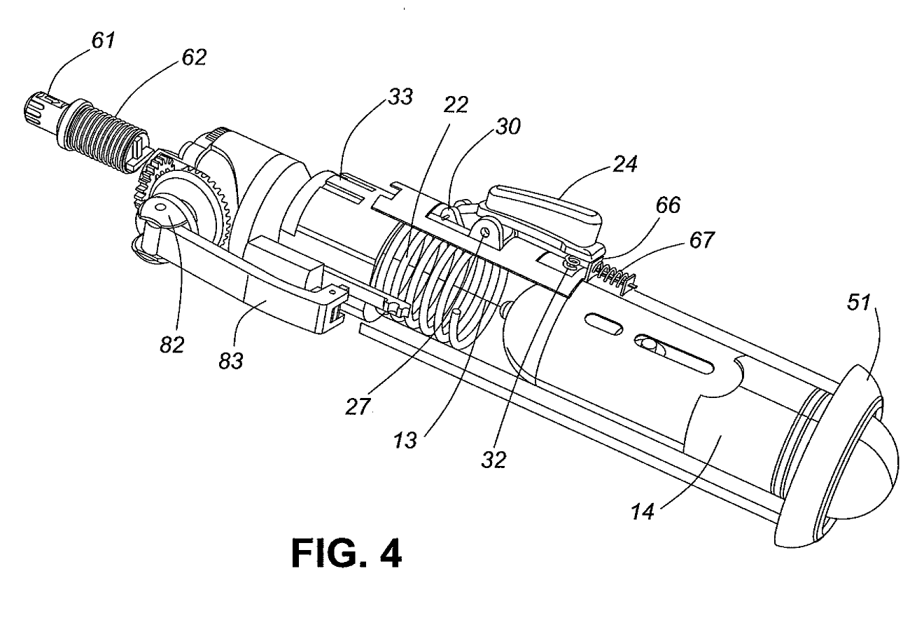

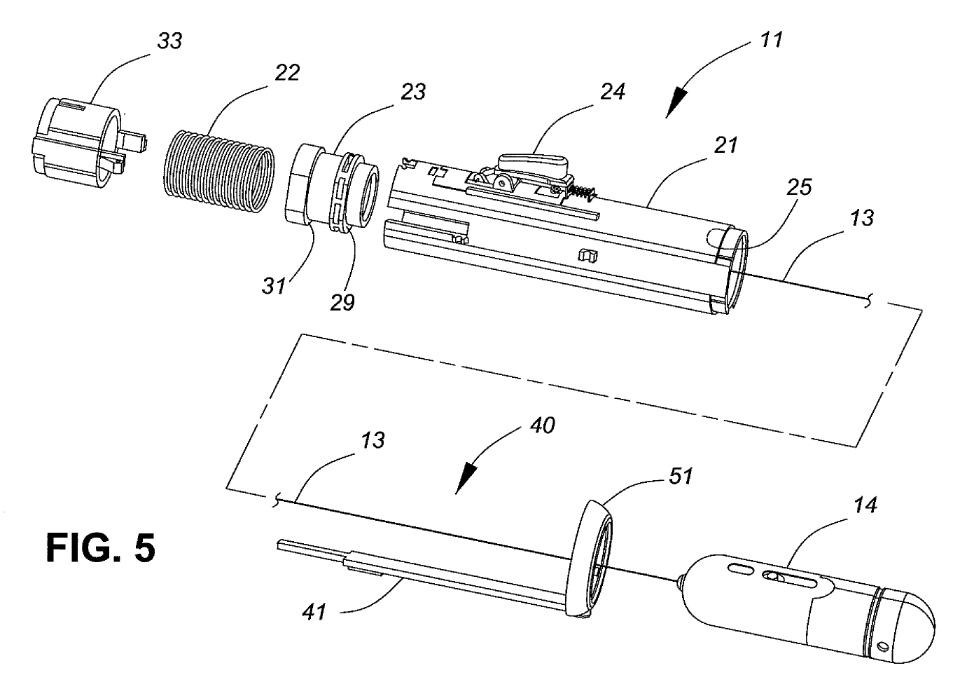

In operation, the compression spring 22 is compressed when the operator inserts the article of fishing tackle 14 into the tubular support member 21 and pushes down on it with his/her hand until the launch trigger pawl 30 “clicks” into engagement with stop face 31 on launch shuttle 23. It is important to note that the fishing line 13 of the applicants' self-propelled cast fishing system travels through the centre of the launch assembly 11 as shown in FIGS. 4 and 5 and is attached to the article of fishing tackle 14. When the operator disengages the safety interlock mechanism 60 as described below and depresses launch trigger 24, launch shuttle 23 is released from engagement with pawl 30 and compression spring 22 is allowed to expand, forcing launch shuttle 23 and article of fishing tackle 14 towards the open end of tubular support member 21. Launch shuttle 23 is retained within tubular support member 21 by means of the engagement of stop face 29 with stop shoulder 25 while the article of fishing tackle 14 is propelled out of the open end of tubular support member 21.

Should the applicants equip the present self-propelled cast fishing system with a sufficiently strong fishing line 13 and a sufficiently robust reel 12, those skilled in the art will appreciate from the description of the launch assembly above, that the reel 12 could be used to compress the compression spring 22 by retracting the article of fishing tackle 14 into the tubular support member 21 against the force of the spring 22, until the pawl 30 is engaged.

### Flex Tip Assembly

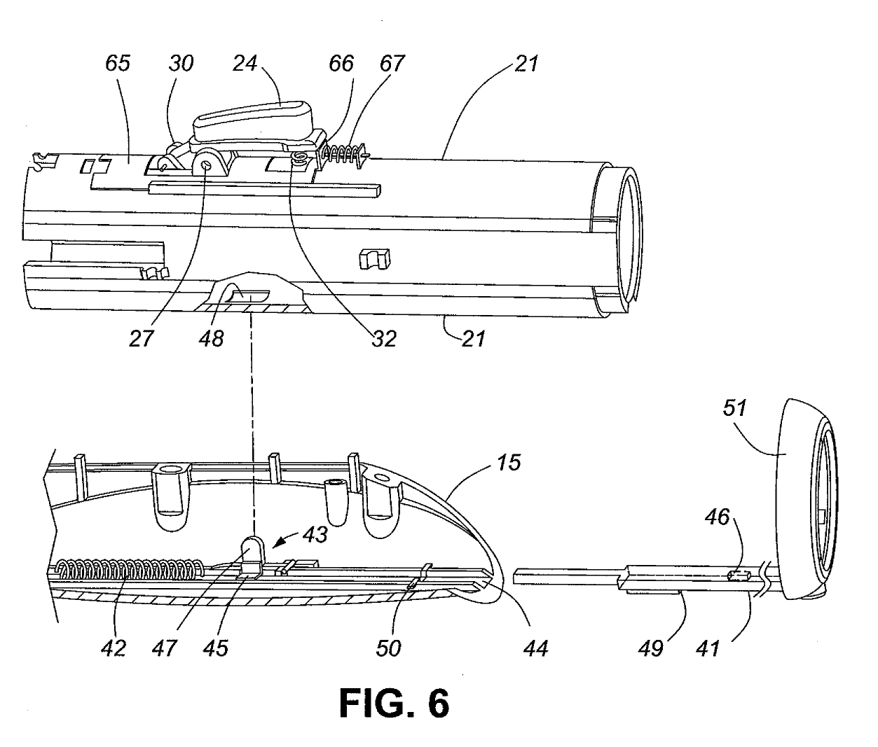

With reference to FIGS. 1B, 5 and 6, in at least one embodiment, the flex tip assembly 40 includes flexible element 41, ejection spring 42 and flex tip latch 43. The flexible element 41 is slidingly retained in track 44 in external cover 15, and can be retracted along track 44, thereby compressing ejection spring 42. Protrusion 45 on flex tip latch 43 engages a recess 46 in flexible element 41, retaining it in the retracted state against the bias of ejection spring 42. Tab 47 on flex tip latch 43 protrudes slightly through an opening 48 in the wall of tubular support member 21 into the bore of tubular support member 21, and as the launch shuttle 23 is launched and passes over the tab 47, the latch deflects sufficiently to disengage the protrusion 45 on flex tip latch 43 from the recess 46 on flexible element 41. When this occurs, the ejection spring 42 pushes the flexible element 41 out of the front end of the tubular support member 21. The flexible element 41 is prevented from being expelled entirely from track 44 by means of a shoulder 49 on flexible element 41, which engages a stop 50 in track 44.

Connected to the flex tip element 41 is an annular line guide 51. The line guide is larger than a typical line guide on a conventional fishing rod and has a large enough internal diameter to allow the article of fishing tackle 14 to pass through. An abrasion resistance liner is contained in the line guide 51, for example, a poly carbonate ring, however, any other material that would resist abrasion/cutting from a fishing line running over it will work as well.

The flex tip assembly 40 forms an important part of the self-propelled cast fishing system to allow the operator to “feel” a nibble of a fish on the hook, and then impact a “jerk” to set the hook in the fish's mouth. With a rigid object it is difficult for an operator to sense this subtle activity at the hook, while flexible element 41 visibly deflects under this activity. Additionally, as the fish fights the force of being reeled in, the flexible element 41 again deflects and provides the operator with what is commonly known as “rod feel” in the cast fishing industry. Since the present self-propelled cast fishing system is designed to be compact, only a short flexible element 41 is provided. Nonetheless, it does serve the purpose of providing “rod feel”.

### Safety Interlock Mechanism

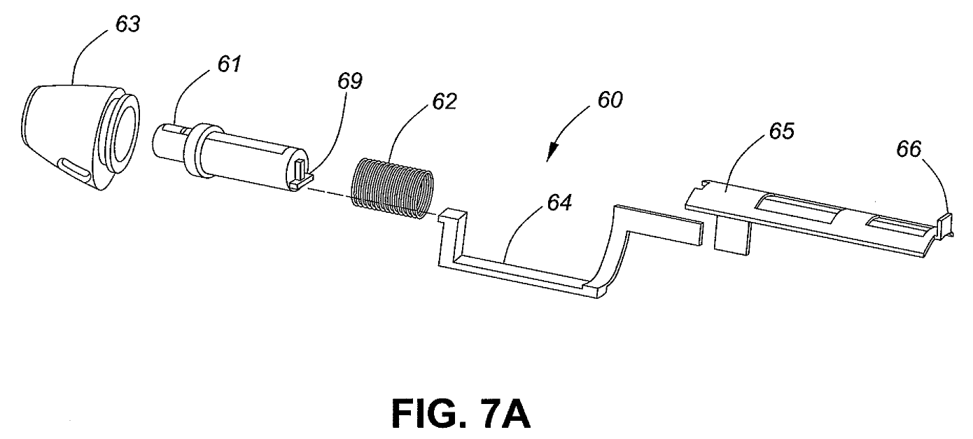

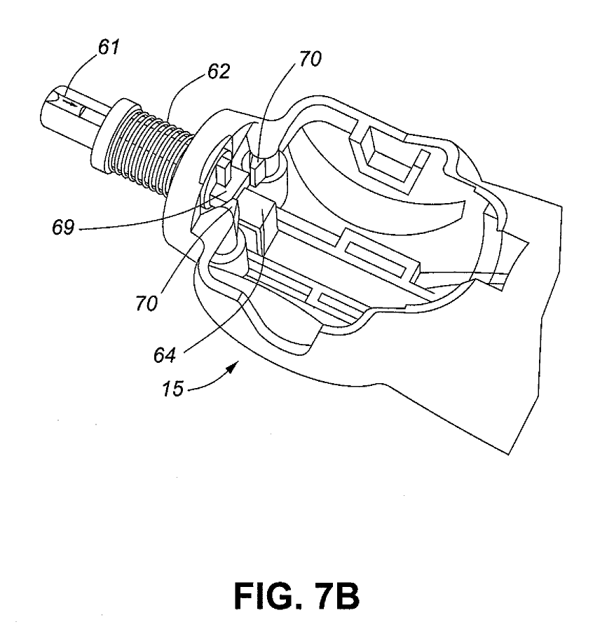

With reference to FIGS. 7A and 7B, in at least one embodiment, the safety interlock mechanism 60 includes safety interlock knob 61 and return spring 62 enclosed in safety interlock cover 63, a slider 64, interlock 65, which includes stop 66, and return spring 67 (shown in FIGS. 2 to 6). Tab 69 located at the end of safety interlock knob 61 contacts one end of slider 64 and the other end of slider 64 is in contact with interlock 65. Referring to FIGS. 2 to 5 and 7A, in operation, the safety interlock knob 61 is biased in the extended position at rest, by means of return springs 62 and 67, positioning stop 66 so as to engage and prevent depression of launch trigger 24. To initiate launch of the article of fishing tackle 14 from the end of tubular support member 21, the operator must first depress and hold safety interlock knob 61, compressing return springs 62 and 67 and moving slider 64 and interlock 65 forward along tubular support member 21. This in turn moves stop 66 forward so that it no longer engages launch trigger 24, which can then be depressed, thus initiating launch. When safety interlock knob 61 is released, return springs 62 and 67 re-expand, returning stop 66 and safety interlock knob 61 to their rest positions and preventing actuation of launch trigger 24.

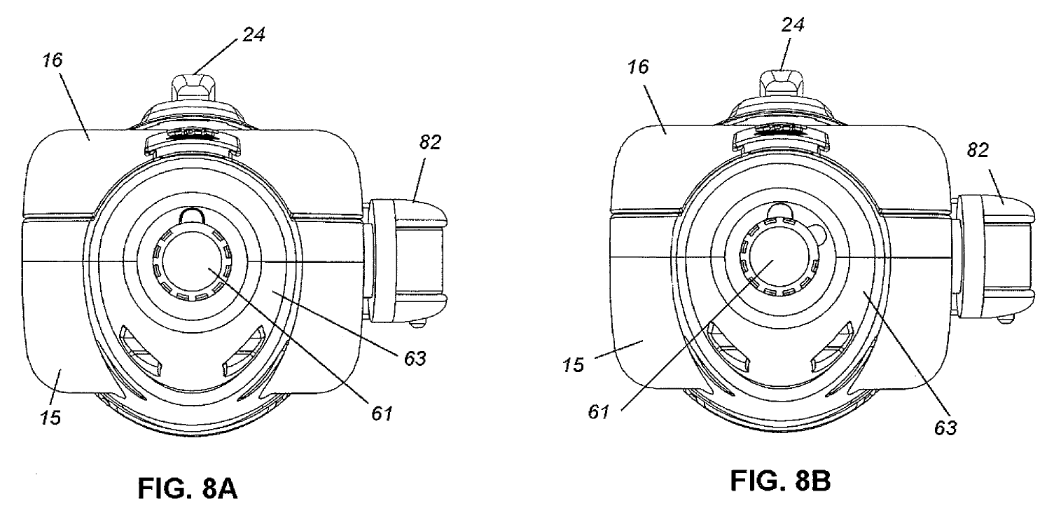

Referring to FIGS. 7B, 8A and 8B, the safety interlock knob 61 is designed so that when the knob is in the twelve o'clock position (FIG. 8A), tab 69 is in contact with slider 64, thus allowing depression of safety interlock knob 61 to activate launch trigger 24. In any other rotary position of the knob (FIG. 8B), tab 69 is in contact with shoulder 70 on the interior of exterior cover 15, thus preventing depression of the safety interlock knob 61. This provides an extra measure of safety in preventing accidental launch of article of fishing tackle 14 from the device.

As described above, the safety interlock mechanism 60 is designed so that the operator must depress both the safety interlock knob 61 and launch trigger 24 to initiate launch of the article of fishing tackle 14 from the end of tubular support member 21. The operator cannot reach both the safety interlock knob 61 and the primary launch trigger 24 with one hand. Therefore, two-handed operation is required to discharge the self-propelled cast fishing system, promoting the operator to always have a positive grip on the unit. In addition, the operator's hands must be clear of the end of the tubular support member 21 while the article of fishing tackle 14 exits, thereby reducing chance of injury. Furthermore, since the most compact storage of the unit is with the article of fishing tackle 14 stored in the tubular support member 21, the safety interlock mechanism 60 reduces the chance of accidental discharge in the operator's pocket, backpack or glove box should the launch trigger 24 be accidentally “bumped”. In at least one embodiment, external covers 15 include a bump guard 28 (FIG. 1A), which further acts to prevent accidental actuation of launch trigger 24.

As described below, the safety interlock mechanism 60 also functions to activate a line release feature in fishing line reel 12 allowing the fishing line 13 to uncoil freely from the reel as the article of fishing tackle 14 travels through its flight path after being expelled from the tubular support member 21. The line release feature is designed so that when the safety interlock mechanism 60 is activated, the fishing line 13 is released prior to the disengagement of launch trigger 24. This ensures that when launch trigger 24 is depressed, fishing line 13 is already free to uncoil from reel 12.

### Fishing Line Reel

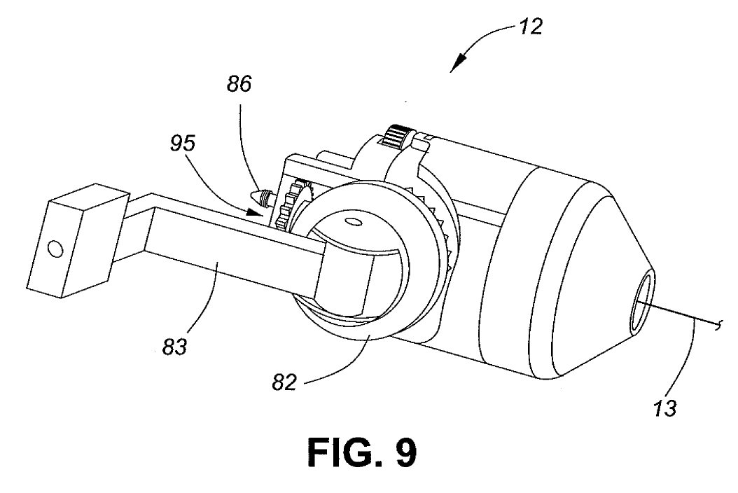

In at least one embodiment, as seen in FIG. 9, the reel 12 is a conventional fishing reel of closed face design. Fishing reel 12 serves the purpose of storing fishing line 13 and allowing it to uncoil as the article of fishing tackle or bobber 14 (also referred to herein as a projectile) is projected from the device. It will be clear to one skilled in the art that the reel 12 can be positioned in any orientation that will permit the fishing line 13 and the article of fishing tackle 14 to be launched and retrieved. The fishing line 13 can be of any type known in the art and is advantageously made of an appropriate material, such as a synthetic polymer, including but not limited to nylon and polyethylene, and is of a weight and strength appropriate to the type of fish that is intended to be caught. The reel 12 also allows the operator to retrieve the article of fishing tackle 14 after launch from the device, as well as any fish caught during use of the present self-propelled cast fishing system, by means of hand crank 82. Hand crank 82 has a conventional anti-reverse mechanism, which allows the handle to crank in only one direction, to prevent “birds nesting” of the fishing line should an operator wind a partly full spool in the wrong direction. Such an anti-reverse mechanism is well known to one skilled in the art. The hand crank 82 includes a folding handle 83 for compact storage.

The fishing reel 12 provides line drag functionality to limit the possibility that a fish may break the line and be left swimming around with a hook in its mouth and a considerable length of line attached. The line drag feature is a conventional clutch mechanism with adjustable preload, such as is well known in the art. As the fish fights back, the clutch slips allowing the spool to unload more line, but not to free wheel. The fish eventually tires from this exercise permitting the fisherman to reel in the fish.

The fishing reel 12 also includes a line release feature, which is actuated by the safety interlock knob 61. This ensures that, when the article of fishing tackle 14 is launched, the fishing line unreels with negligible force so that as little as possible of the stored energy in the launch spring is lost and the farthest possible cast distance is achieved. The line release feature is designed so that when the safety interlock knob 61 is depressed, the fishing line 13 is released prior to the disengagement of launch trigger 24, so that when launch trigger 24 is depressed, fishing line 13 is already free to uncoil from reel 12.

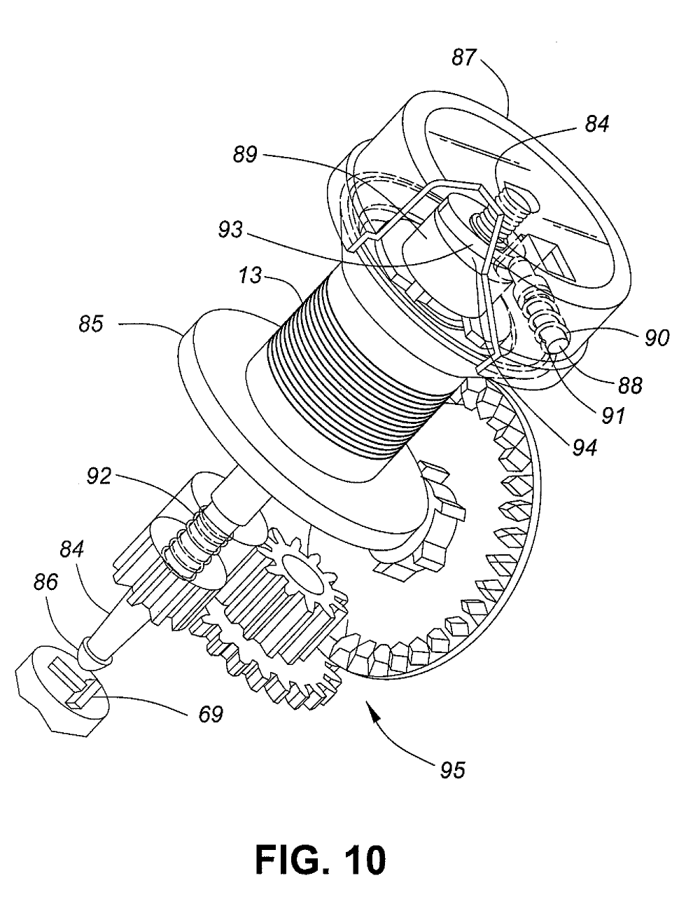

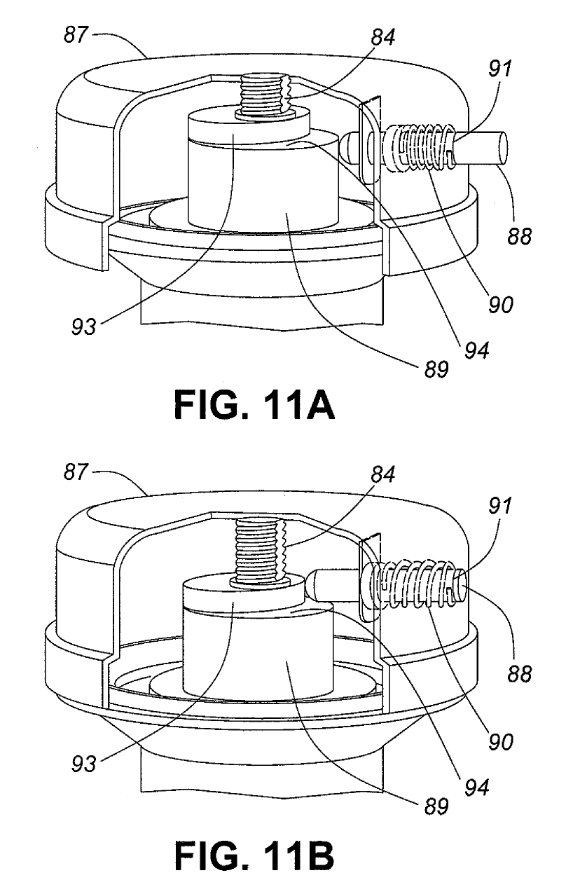

Referring to FIGS. 10, 11A and 11B, the line release mechanism includes release shaft 84, which is D-shaped in cross-section and which passes through a circular bore in spool 85, through which shaft 84 can be freely rotated. Release shaft 84 has release tip 86 at one end and is attached to spool cover 87 at the other end. As shown in FIG. 11A, when the reel assembly is engaged, line catch pin 88 is urged by shoulder 89, against the bias of compression spring 90, through an opening 91 in spool cover 87, and engages fishing line 13 (not shown). As shown in FIGS. 10 and 11B, when the safety interlock knob 61 is depressed by an operator, it contacts release tip 86, urging release shaft 84 and attached spool cover 87, against the bias of compression spring 92, away from spool 85. Line catch pin 88 is urged against shoulder 93 by compression spring 90 and retained by lip 94 against the bias of compression spring 92, so that line catch pin 88 no longer protrudes through opening 91, releasing fishing line 13 and allowing it to pass freely from spool 85. When hand crank 82 (FIG. 9) is operated, release shaft 84 and attached spool cap 87 are rotated through the interaction of gear train 95, and line catch pin 88 travels along lip 94, being gradually urged outwards by shoulder 93 against the bias of spring 90. When line catch pin 88 has traveled to the point where shoulder 93 is flush with shoulder 89, so that lip 94 no longer retains line catch pin 88, release shaft 86 and spool cover 87 are urged back towards spool 85 by compression spring 92. Shoulder 89 again urges line catch pin 88 through opening 91, so as to again engage fishing line 13, allowing the operator to reel in a fish.

### Article of Fishing Tackle

The purpose of the article of fishing tackle or bobber 14 is to carry the tackle, that is, the bait, and hook to catch a fish. The article of fishing tackle 14 is similar to that described in U.S. Pat. No. 6,880,286, which is herein incorporated by reference. The applicants describe the present self-propelled cast fishing system as being capable of launching an article of fishing tackle 14, however, those skilled in the art will appreciate that other suitable projectiles could be launched as well. For example, one could contemplate launching a “hook hiding lure”, or other mechanism to attract or catch fish.

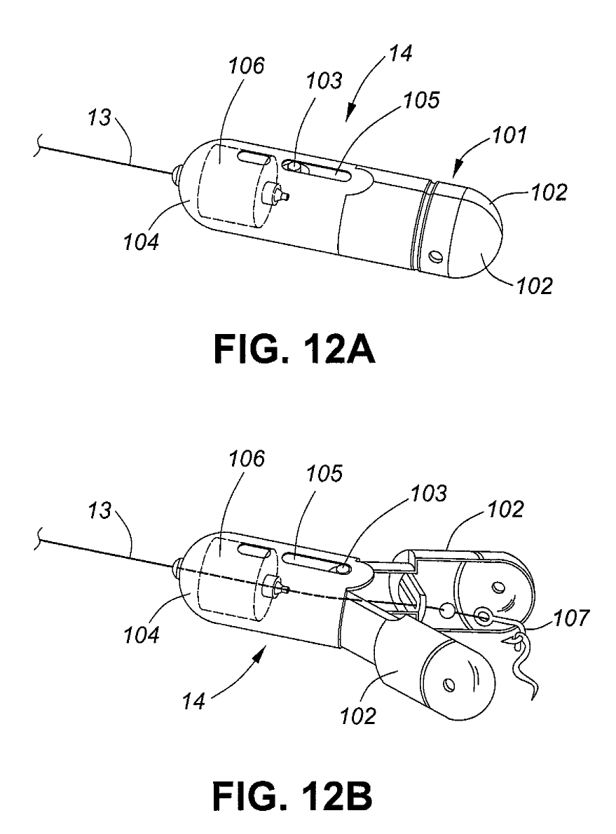

Referring to FIGS. 12A and 12B, in at least one embodiment, the distal half 101 of the article of fishing tackle 14 is a “split clamshell” arrangement. Clamshell sides 102 can be opened and closed by rotation about pivot pin 103 and, in the closed state, distal half 101 can be recessed into the proximal half 104 of the article of fishing tackle 14 by sliding pivot pin 103 inwards in slot 105, so as to prevent clamshell sides 102 from opening. In operation, when the article of fishing tackle 14 hits the water, the proximal half 104 floats on the surface, aided, for example, by a float 106 contained in proximal half 104. The weight of the distal half 101 and its contents, including, for example, tackle 107 and/or a weight (not shown) attached to one or both of clamshell sides 102 to aid the opening of distal half 101, causes pivot pin 103 to slide outwards in slot 105 under the force of gravity or of the motion of the article of fishing tackle 14, thereby allowing clamshell sides 102 to open, releasing tackle 107 attached to fishing line 13. If a weight is attached to one or both of clamshell sides 102, it is advantageously located in the portion closer to pivot pin 103, so as to maximize the opening of clamshell sides 102 upon entry into the water.

The previous detailed description is provided to enable any person skilled in the art to make or use the present self-propelled cast fishing system. Various modifications to those embodiments will be readily apparent to those skilled in the art, and the generic principles defined herein may be applied to other embodiments without departing from the spirit or scope of the self-propelled cast fishing system described herein. Thus, the present self-propelled cast fishing system is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A self-propelled cast fishing system comprising:
a launch mechanism comprising:
a tubular support member comprising a bore, a first end and a second end;
a compression spring fixedly positioned at the first end of the tubular support member;
a retaining mechanism for retaining the compression spring in a compressed position; and
a release mechanism for releasing the compression spring to an extended position; and
a safety interlock mechanism, the safety interlock mechanism preventing activation of the release mechanism when in a rest state and allowing activation of the release mechanism when in an activated state;
a reel;
an article of fishing tackle positionable within the bore of the tubular support member such that activation of the release mechanism acts to propel the article of fishing tackle from the second end of the tubular support member; and
fishing line comprising a first end and a second end, the first end fixed to the reel and the second end fixed to the article of fishing tackle.

2. The self-propelled cast fishing system of claim 1 wherein the fishing line passes between the reel and the article of fishing tackle through the bore of the tubular support member.

3. The self-propelled cast fishing system of claim 1 wherein the retaining mechanism comprises:
a shuttle positioned in the bore of the tubular support member and slidable between a first position at the first end of the tubular support member and a second position at the second end of the tubular support member;
wherein the shuttle is biased in the second position and wherein the shuttle engages and compresses the compression spring when the shuttle is in the first position; and
a pawl biased to engage the shuttle when the shuttle is in the first position and to retain the shuffle in the first position.

4. The self-propelled cast fishing system of claim 3 wherein the release mechanism comprises a release trigger interacting with the pawl such that when the release trigger is activated by a user, the pawl is moved out of engagement with the shuttle.

5. The self-propelled cast fishing system of claim 4 wherein the safety interlock mechanism comprises:
a safety interlock biased to engage the release trigger so as to prevent activation of the release trigger by a user; and
a safety interlock knob engaging the safety interlock;
wherein when a user activates the safety interlock knob, the safety interlock is moved out of engagement with the release trigger and the release trigger is activatable by the user.

6. The self-propelled cast fishing system of claim 1 further comprising a flex tip assembly retractably positioned at the second end of the tubular support member,
wherein the flex tip assembly comprises a flex tip element and an annular line guide;
wherein the annular line guide has an internal diameter sufficient to allow the article of fishing tackle to pass therethrough.

7. The self-propelled cast fishing system of claim 5 wherein the reel comprises a line release mechanism such that activation of the line release mechanism allows the fishing line to be unreeled with negligible force, wherein the line release mechanism is activated when a user activates the safety interlock knob.
